(19) United States
(12) Patent Application Publication
(10) Pub. No.: US 2008/0178087 A1
(43) Pub. Date: Jul. 24, 2008

(54) In-Scene Editing of Image Sequences

(75) Inventors: Andrew Fitzgibbon, Cambridge (GB); Toby Sharp, Highfields Caldecote (GB)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/625,049

(22) Filed: Jan. 19, 2007

(51) Int. Cl. G11B 27/00; G06F 3/00

(52) U.S. Cl. 715/723; 386/52

(57) ABSTRACT

Using in-scene editing, an added title, or object, moves as the camera moves through the imaged scene. Previously this has been complex to achieve, requiring expert users to explicitly align 3D coordinate systems in the image sequence and on the added title or object. For example, this has been used to add 3D objects into live-action footage in big-budget movies or advertising. A simple, easy to use system is described for achieving in-scene editing. A user specifies projection constraints by making 2D actions on one or more images in the image sequence. A 3D motion trajectory is computed for a 3D object model on the basis of the specified projection constraints and a smoothness indicator. Using the computed trajectory the 3D object model is added to the image sequence. Projection constraints may be added, amended or deleted to position the 3D object model and/or to animate it.

### BACKGROUND

A visual effect commonly observed in movies or advertising is the insertion of 3D objects into action footage. For example, a helicopter fly-through of New York may be modified by placing a virtual advertising hoarding on top of a building which is seen in the movie. However, existing technologies to achieve this are extremely complex, requiring the user to explicitly align 3D coordinate systems in the movie and in a model of the virtual advertising hoarding. Expert users are needed to carry this out and the process is time consuming, expensive and error prone.

In addition there is a growing demand for home video editing systems which enable objects to be added to a scene depicted in a home video. Most video captured by home users is of 3D activity in a 3D world. Editing and interaction with the video, however, remains based on 2D interface paradigms which have arguably evolved little from the era of film, scissors and tape.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

Using in-scene editing, an added title, or object, moves as the camera moves through the imaged scene. Previously this has been complex to achieve, requiring expert users to explicitly align 3D coordinate systems in the image sequence and on the added title or object. For example, this has been used to add 3D objects into live-action footage in big-budget movies or advertising. A simple, easy to use system is described for achieving in-scene editing. A user specifies projection constraints by making 2D inputs on one or more images in the image sequence. A 3D motion trajectory is computed for a 3D object model on the basis of the specified projection constraints and a smoothness indicator. Using the computed trajectory the 3D object model is added to the image sequence. Projection constraints may be added, amended or deleted to position the 3D object model and/or to animate it.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIGS. 1A, B and C show images in a sequence of images in which layer based editing has been used;

FIGS. 2A, B and C show images in a sequence of images after in-scene editing;

FIGS. 3A, B and C show images in a sequence of images presented in a user interface display with a timeline;

FIG. 4 is a flow diagram of a method carried out by a user to achieve in-scene editing;

FIG. 5 illustrates an example method of pre-processing an image sequence;

FIG. 6 is an example method of adding a 3D object model to a sequence of images;

FIG. 7A illustrates an image of an object in a sequence of images;

FIG. 7B illustrates another image from the same sequence of images as for 7A;

FIGS. 8A and B illustrate images from a sequence of images with different types of projection constraint;

FIGS. 9A and 9B illustrate images from a sequence of images where projection constraints are used to give animation;

FIG. 10 is a schematic diagram of an apparatus for in-scene editing of a sequence of images;

FIG. 11 illustrates an exemplary computing-based device in which embodiments of the in-scene editing methods described may be implemented.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

Although the present examples are described and illustrated herein as being implemented in an in-scene image editing system such as for home video editing, the system described is provided as an example and not a limitation. As those skilled in the art will appreciate, the present examples are suitable for application in a variety of different types of image editing systems including commercial movie editing systems. In many of the examples described, the motion of the camera with respect to the scene is a simple linear translation for clarity of depiction in the drawings. However, this is in no way intended to limit the invention to such types of translation. The image sequence may be associated with any camera motion including rotation, pan and tilt.

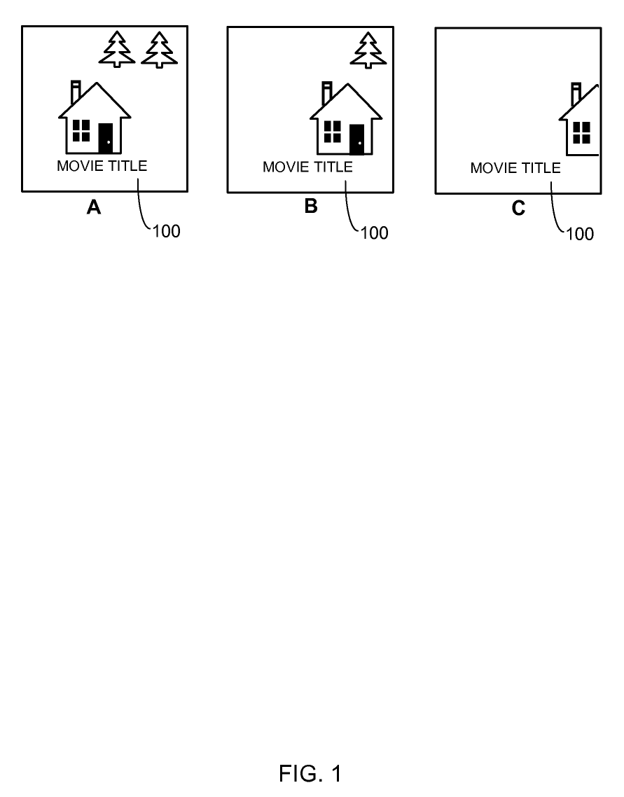

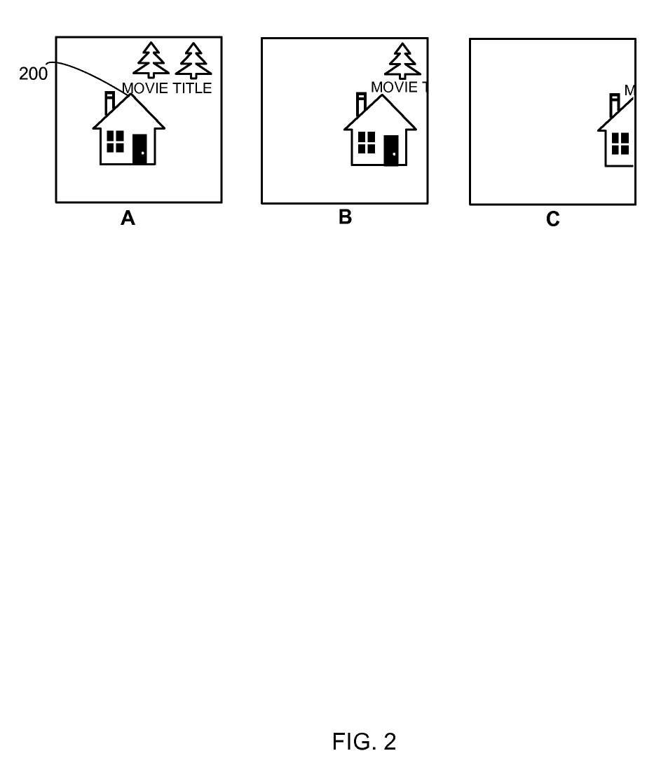

FIGS. 1A, 1B and 1C show images in a sequence of images in which layer based editing has been used. The words “MOVIE TITLE” 100 have been added to the centre of the display and this is repeated in each image of the sequence. This method can be thought of as placing the words “MOVIE TITLE” in a 2D layer superimposed on a movie film, emulating the practice of printing titles on a transparent mylar sheet and overlaying the sheet on the movie film. In contrast, with in-scene editing, the added title, or object, moves as the camera moves through the imaged scene. This is illustrated in FIGS. 2A to C.

FIGS. 2A, B and C show images in a sequence of images after in-scene editing. Here the words “MOVIE TITLE” have been added such that they are attached to the roof of the house at 200. As the camera moves between images in the sequence the words “MOVIE TITLE” move out of view as does the house. Methods for achieving this in-scene editing are described herein which are simple to use and extremely effective. In the example, shown in FIG. 2A to C the camera motion is a simple translation. However, it is also possible for this to be a complex translation with rotation and changes in depth. For example, the camera might move to view the back of the house or to take a bird's eye view of the house. It is also possible for the added object (in this example, the words MOVIE TITLE) to be animated using methods described herein. A simple graphical user interface is provided to enable this in-scene editing to be achieved quickly and simply by a novice user such as for a home video editing application or alternatively for commercial editing of movies in a large enterprise.

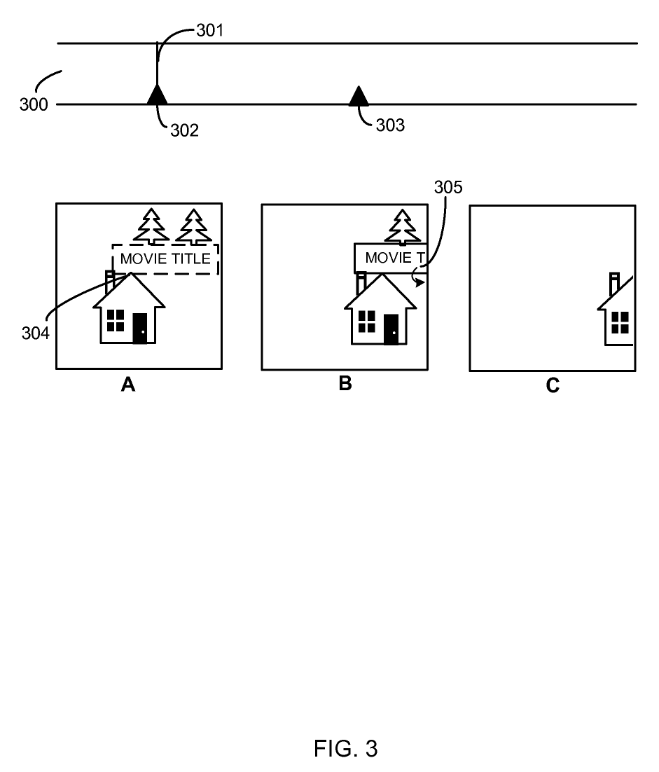

A user interface is provided, for example, FIGS. 3A, B and C show images in a sequence of images presented in a user interface display with a timeline 300. A vertical bar 301 displayed in the timeline may be dragged to different positions in the timeline in order to select different ones of the images in the sequence of images. The image displayed directly under the vertical bar 301 is the image which is currently selected. Markers 302, 303 may be displayed in the timeline to indicate which of the images in the sequence already have projection constraints recorded in conjunction with those particular images. Projection constraints and the manner of recording these are described in more detail later. A image from the sequence which has one or more projection constraints recorded in conjunction with it is referred to as a keyframe.

The user interface also provides controls (not shown) to enable a user to play the sequence of images, scan or scrub through that sequence of images, and optionally play the sequence of images in reverse. These controls may take the form of buttons, slide bars, or any other suitable controls.

As illustrated in FIG. 3A the 3D object comprising the words MOVIE TITLE have been positioned by the user with a bottom left hand corner of the object being located on the roof of the house depicted in the image. This is achieved by the user dragging a control point (also referred to herein as a handle) 304 of the 3D object onto a particular point on the house as he or she requires. This 2D target position specified by the user in the image using control point 304 is an example of a projection constraint. In this way the user is able to specify a projection constraint for the 3D object. Information about the projection constraint is stored and an indicator 302 displayed in the timeline of the user interface to indicate the presence of the projection constraint specified in that image. The user is able to add, delete or edit projection constraints using the user interface. In different images of the sequence different objects in the scene may be visible from different orientations and thus it may be easier for a user to specify certain projection constraints when viewing particular images of the sequence.

As illustrated in FIG. 3B another type of projection constraint may comprise rotation information 305. For example, this may be specified by a user making an action to rotate the 3D object in a particular view to a chosen position relative to other objects in the scene. Any suitable user action may be selected for this purpose. For example, using a mouse wheel.

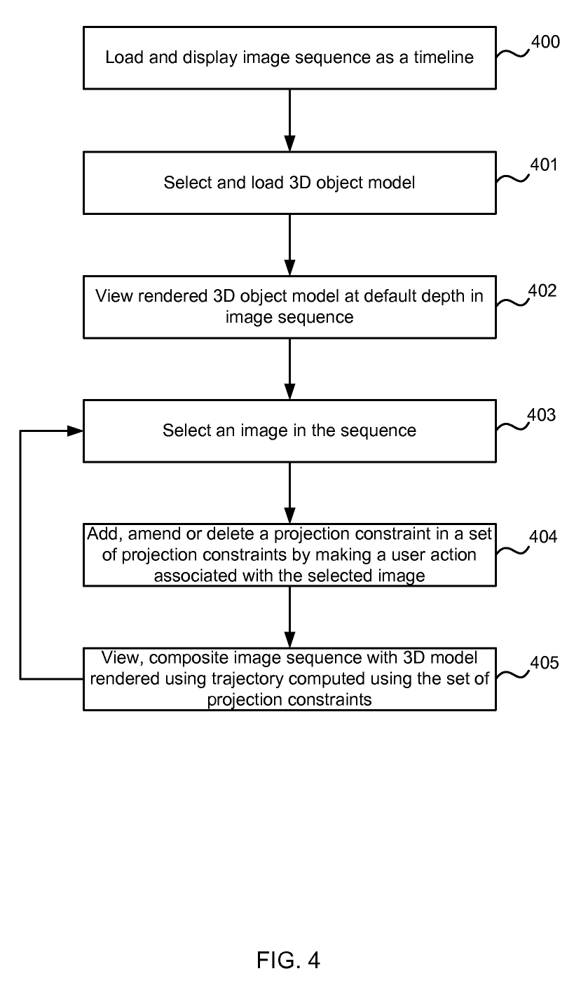

FIG. 4 is an example of a method of using a system for in-scene editing of image sequences. The user first activates the system such that an image sequence is loaded and displayed as a sequence with a time line (block 400). The sequence of images may be of any suitable type such as images from a video stream, images from a movie film, images from a web camera, or any other suitable sequence of images. The user then selects and causes a 3D object model to be loaded to the system. The 3D object model may be of any suitable type. It may be a single point, a model of an object, a model of part of an object or a model of several adjacent objects. Any suitable representation may be used for the 3D object model provided that it enables a display of that model to be rendered on a user interface display with suitable orientation and scale. For example, a polygonal mesh representation may be used or a representation comprising a list of implicit surfaces, or a representation defined by computational solid geometry, or a representation suitable for point-based rendering. In the case that the 3D object model comprises a text string such as a movie title or advertising banner, the user is able to enter a text string which is converted automatically to a 3D object model. The 3D object model may comprise one or more pre-defined control points or handles that may be used by the user in the process of specifying projection constraints. This is explained in more detail below. However, it is not essential for pre-defined control points or handles to be provided.

The system renders the 3D object model at a default position in the image sequence (block 402) and the user views this rendered display by activating the controls on the user interface as mentioned above. Any default position may be used. For example, the object may be rendered at a default depth, precomputed offline as the average distance from the camera to scene points in a given image. Thus on scrubbing through the timeline the object will generally appear to float in mid air. However, it is not essential to use the average distance from the camera to scene points as the default position for the 3D object model. Other default positions related to the relative distance from the cameral to scene points may be used.

The user selects an image in the sequence (block 403) at which it is desired to specify one or more projection constraints. This is done using the user interface controls mentioned above to move between images in the sequence. The user then adds, amends or deletes a projection constraint by making a user action associated with the selected image (block 404) which is also referred to as a keyframe. A set of projection constraints exists associated with the sequence of images and this may comprise zero projection constraints at the beginning of the process. As the user carries out in-scene editing using the system, projection constraints are added to this set and may be amended or deleted using the user interface. A projection constraint comprises any information which contributes to enabling a point on the 3D object model to be specified in the scene coordinate system. For example, a projection constraint may be a 2D point in a keyframe to which a specified control point or handle on the 3D object must project in the scene coordinate system.

For example, the user may add a projection constraint to align the 3D object model with some real world objects visible in the image sequence. To align the 3D model to a world feature, the user may drag a 2D representation of a handle 304 to align with a feature (such as the top of the roof of the house) in a keyframe (such as image A of FIG. 3A).

The user is now able to view a composite image sequence in which the 3D object model is added using in-scene editing. The system computes a 3D motion trajectory for the motion of the 3D object model in the image sequence as described in more detail below. The projection constraints are used in this computation. The 3D motion trajectory is use to display the composite image sequence which is viewed by the user (block 405).

For example, suppose that so far only one projection constraint has been specified as described above with reference to FIG. 3A. Scrubbing to a different point on the timeline will move the object (in this case the words MOVIE TITLE) with the 3D scene but the depth is not yet constrained so the 3D object may drift away from the anchoring roof feature. The user is then able to repeat the process in order to specify more projection constraints (block 403). For example, dragging the handle 304 back to rest on the anchor feature (top of roof) provides depth information throughout the image sequence and enables the 3D object to be locked into position in all images of the sequence. A rotation projection constraint may be specified as indicated at 305 in FIG. 3B. Further edits to projection constraints may be made in other keyframes in order to animate trajectories or to repair drift in long sequences.

A scene coordinate system is computed for the scene depicted in the sequence of images. This process may be carried out offline. However, this is not essential, the scene coordinate system may also be computed during operation of the in-scene editing system provided that sufficient processing capacity is available to achieve this in a time that is workable and user friendly.

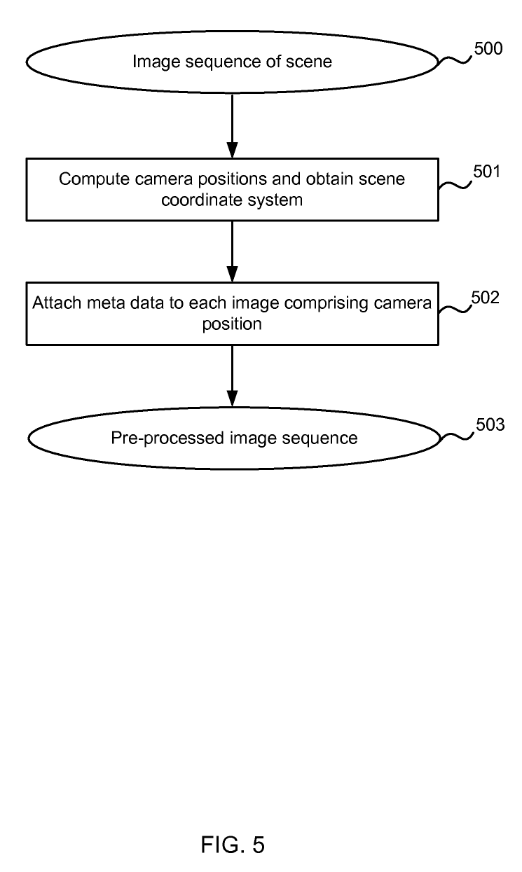

As illustrated in FIG. 5 an image sequence of a scene 500 is accessed and a camera position is computed for each image in the sequence such that a scene coordinate system may be estimated for the scene depicted in the image sequence (block 501). The camera position information and scene coordinate system information is stored in any suitable manner. For example, metadata is attached to each image in the sequence comprising a camera position for that image (block 502). The pre-processed image sequence (503) may then be stored.

The process of obtaining the scene coordinate system may comprise determining camera positions and an intrinsic calibration function as described in more detail below. Software applications for achieving this are currently commercially available and are referred to as matchmoving applications. For example Matchmover™ by Realviz S. A. and Syntheyes™ by Andersson Technologies LLC. Details of a suitable matchmoving process are also given in Fitzgibbon and Zisserman “Automatic Camera Recovery for Closed or Open Image Sequences” Proceedings of the 5th European Conference on Computer Vision-Volume I-Pages: 311-326, 1998, ISBN:3-540-64569-1.

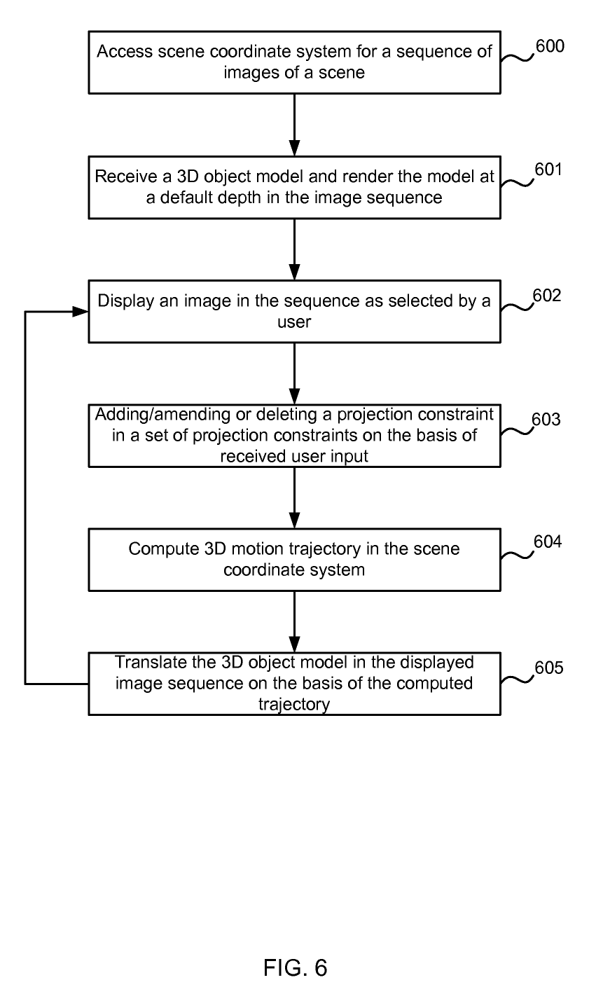

FIG. 6 is an example of a method carried out at a system for in-scene editing of image sequences. A scene coordinate system is accessed for s sequence of images of a scene (block 600). For example, the scene coordinate system is computed offline, or is accessed from another system, or is computed at the system itself.

A 3D object model to be added to the image sequence is received (block 601). This 3D object model is rendered at a default position in the image sequence (block 601) and a user may view the resulting display as described above. An image in the sequence is displayed as selected by a user (block 602). The system then adds, amends or deletes a projection constraint in a set of projection constraints on the basis of received user input (block 603). The system computes a 3D motion trajectory in the scene coordinate system (block 604). This 3D motion trajectory is computed such that the set of projection constraints are taken into account and such that a smoothness measure of the 3D motion trajectory is optimized. Any suitable smoothness measure may be used as described in more detail below. For example, a thin-plate spline smoothness indicator may be used. Another option is to use a smoothness measure related to arc-length cost as described below. Other smoothness measures may be used such as combinations of thin-plate spline smoothness and arc-length cost indicators, or a smoothness measure related to curvature cost.

The 3D object model is then transformed in the displayed image sequence on the basis of the computed trajectory (605) and the method may be repeated as required.

Thus the system enables untrained users to position 3D objects in an image sequence using only 2D user interactions. The user is presented with a user interface (which may be 2D) that is intuitive and simple to use. On a given frame (image in the sequence) the user loads a 3D model (for example, from a gallery) and it appears on the image (such as a video frame). This is achieved without the need for any projection constraints to be specified. By adding and editing projection constraints as described above the user is able to anchor the 3D object model to features in the scene depicted in the image sequence and/or to animate the 3D object. No explicit manipulation of the 3D model is required. Thus, a 3D motion trajectory for the 3D model is computed effectively using only 2D information and without the need to manipulate 3D icons.

The system is robust to erroneous user input because any projection constraint may be edited or removed at any time. Any error in user input will cause the rendered model to appear in an undesired place on the screen, and will therefore be visible to the user. The user may therefore repair any erroneous inputs by using an “undo” command on the user interface, by removing constraints, or by adding new constraints which re-position the erroneously displayed model.

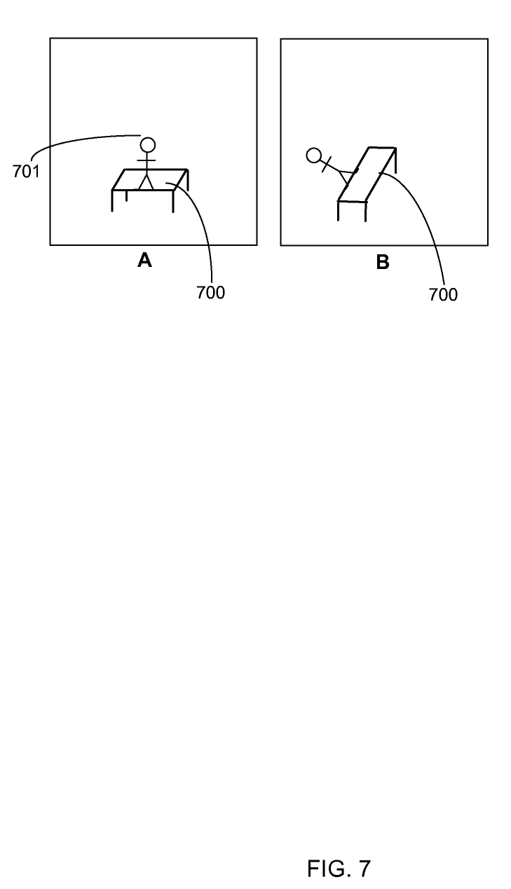

Because the user is able to edit the projection constraints using any of the images in the sequence of images the process of specifying projection constraints is simplified. For example, FIG. 7 illustrates two keyframes A and B from a sequence of images. A 3D object model 701 of a stick-man is being added to the image sequence. In keyframe A, a user has dragged control points on the feet of the stick-man onto features at the edge of an image of a table 700. Whether the stick-man has been positioned so that he is standing vertically upwards cannot be assessed in this keyframe. However, at keyframe B it can be seen that the stick-man is inclined. Using this keyframe the user may use rotation controls on the user interface to specify another projection constraint enabling the stick-man to be stood vertically upwards from the table 700.

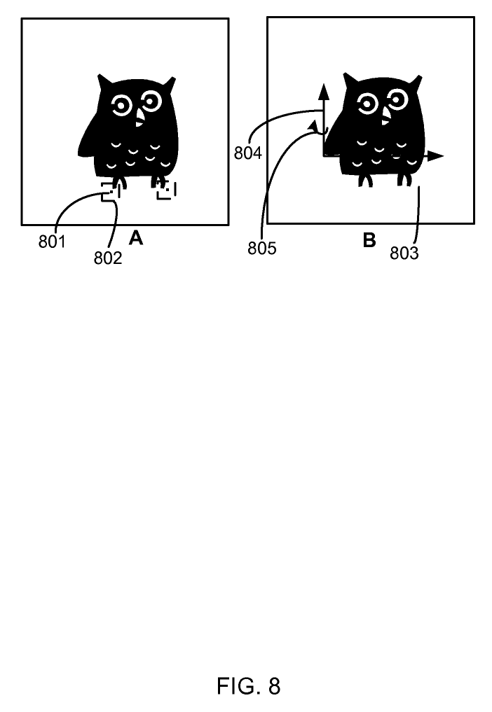

Methods of enabling users to specify projection constraints using the user interface may be of any suitable type. For example, FIG. 8A shows a keyframe depicting an owl as the 3D object model with control points 802 indicated using markers 802. These markers 802 may be dragged by a user such that they are centered on features 801 at which the control points are to be anchored.

FIG. 8B shows another keyframe depicting an owl as the 3D object model. Guide arrows 803, 804 are displayed extending from a specified point on the 3D object model (in this case the wing tip). The user may select a point on each of these arrows in order to specify information about a projection constraint. A rotation about one of the guide arrows 805 may also be specified to give another projection constraint.

Depending on the type of projection constraints used the number of projection constraints required to fully lock the 3D object model in the scene varies. However, this number is typically relatively small, 5 or fewer for example. This means that the user is not required to make extensive edits to the image sequence in order to carry out the in-scene editing.

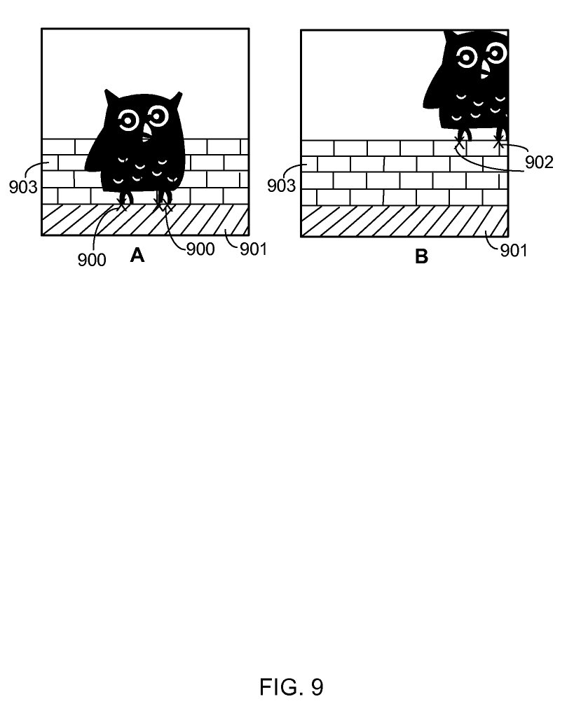

As mentioned above, the system may also be used for animation. For example, FIG. 9 shows two keyframes A and B from a sequence of images in which the 3D object model is an owl. In keyframe A the owl is shown standing on ground 901 in front of a brick wall 903. In keyframe B the owl is standing on the brick wall 903. In keyframe A projection constraints 900 are added by dragging control points on the owl's feet onto features on the ground. In keyframe B projection constraints 902 are added by dragging the control points on the owl's feet onto features on the top of the wall. When the image sequence is played the owl is animated and moves from the ground 901 onto the wall 903. In this way animation effects are achieved in a simple and effective manner. Other types of projection constraint may be used to achieve animation. For example, by adding rotation projection constraints the owl could be made to take a 360 degree turn whilst jumping from the ground to the wall. The projection constraints are added to the set of projection constraints as described in the methods above and the 3D motion trajectory that is computed may then comprise animation depending on the nature of the projection constraints specified.

The projection constraints may be implemented as either hard or soft constraints. In the case of hard constraints, the 3D motion trajectory must be computed such that it meets those constraints. In the case of soft constraints the 3D motion trajectory is computed to optimize those constraints together with the smoothness indicator.

Optionally prespecified limits are set to prevent a user from specifying projection constraints that would give extreme results. For example, to prevent the added 3d object model from appearing behind the camera or at unnatural scales. These prespecified limits may be set such that a front and back plane are specified between which the 3D object model may be placed.

An example method of positioning a 3D object model in an image sequence is now described in detail.

The input video is a sequence of n 2D images, {Iₖ}ₖ₌₁ⁿ. An image I is a function I(x,y), returning the colour at each pixel (x,y). With each image Iₖ is associated a camera position Cₖ, represented as a 3D vector, and an intrinsic calibration function dₖ(x,y) which maps 2D image coordinates to 3D rays in a coordinate system with origin at Cₖ. Thus the pixel at (x,y) in image k views a point on the 3D ray

Rₖ(x,y)={Cₖ+zdₖ(x,y)|0<z<∞}

The Cₖ and dₖ may be available from an offline calibration stage. Projection from 3D to 2D is via a function p:R³ [symbol] R², defined by

pₖ(X)=(x,y) [symbol] XεRₖ(x,y)

A 3D model may be represented as a set of 3D points M, defined by

M={X^{m}}ₘ₌₁^{|M|}.

Finite point sets are considered here and it is assumed that the points represent the 3D surface in some conventional way, say as the vertices of a polyhedral model. The model may of course be augmented with components defined in other ways (for example the zero sets of algebraic surfaces specified by a set of parameters). The points are assumed to be numbered such that vertices X¹ and X² are predefined handles: model points whose position may be externally specified, thereby rotating, translating, and scaling the 3D model.

### Offline Calibration

This phase takes advantage of the fact that uploading of Image sequences such as video from camera to computer is a time-consuming process, which is therefore generally run unattended. By computing additional preprocessing information at this stage, powerful operations are offered to the user at edit-time without slowing down user interaction.

The task of offline calibration is to determine the camera parameters defining the camera position Cₖ and intrinsic calibration function dₖ. This is a standard task performed by matchmoving applications, which process an image sequence, and return camera parameters in several formats.

Using the calibration function dₖ allows all such camera formats to be treated uniformly. One common format associates with each image its position Cₖ, a 3×3 rotation matrix Rₖ and a camera calibration matrix Aₖ, so that

$${d}_{k} ( x , y ) = {R}_{k}^{T} {A}_{k}^{- 1} ( \begin{matrix}x \\ y \\ 1\end{matrix} ) ,$$

and the corresponding projection function p(X) is then

pₖ(X)=π(AₖRₖ(X−Cₖ))

with π(x,y,z)=(x/z,y/z) and where pₖ(Cₖ+zdₖ(x,y))=(x,y) for all z. This phase therefore defines a 3D coordinate system for the scene within the image sequence.

### Online Object Positioning

Positioning a 3D object in the image sequence is achieved by assigning 3D coordinates to two or more handles on the 3D model. Considering a particular handle X, the task of positioning is to specify X in the scene coordinate system defined by offline calibration. This is achieved by indicating the 2D point to which X must project in a number of keyframes, with indices {k₁, . . . k_{K}}. Thus the input is a set of 2D vectors v_{1 . . . K}, which impose constraints of the form

$$\begin{matrix}{p}_{{k}_{1}} ( X ) = {v}_{1} & ( 1 ) \\ {p}_{{k}_{2}} ( X ) = {v}_{2} & ( 2 ) \\ ⋮ & ( 3 ) \\ {p}_{{k}_{K}} ( X ) = {v}_{K} & ( 4 )\end{matrix}$$

In the present methods the problem is formulated as finding the smoothest 3D trajectory which obeys the projection constraints. The 3D trajectory is represented by the 3D curve Q={X(t)|1≦t≦n}. Smoothness of a curve may be defined in a number of ways. In general, it will be written as the negative of a smoothness penalty function ε(Q) applied to the curve Q.

One example is the thin-plate spline (TPS) smoothness

$$ɛ ( Q ) = {\int }_{t = 1}^{n} {‖ \frac{{\partial }^{2} X ( t )}{\partial {t}^{2}} ‖}^{2} d t ,$$

and another is the arc length

$$ɛ ( Q ) = {\int }_{t = 1}^{n} ‖ \frac{\partial X ( t )}{\partial t} ‖ d t .$$

Embodiments using the TPS smoothness are now described.

### Thin-Plate Spline Trajectory

The above expressions are written in terms of the infinite set Q of all points on the curve. For practical implementation, it is assumed that the input image sequence was captured at uniform time intervals, so that the curve may be represented by its values \hat{Q} at the integer time instants tε{1,2, . . . ,n}, and the TPS smoothness term may be approximated using finite differences:

$$ɛ ( \hat{Q} ) = {\sum }_{t = 2}^{n - 1} {‖ X ( t - 1 ) - 2 X ( t ) + X ( t + 1 ) ‖}^{2}$$

Thus the computational task is to find the set of n 3D points \hat{Q} which minimize ε(\hat{Q}) subject to the projection constraints

pₖ_{_{c}}(X(k_{c}))=vₖ_{_{c}} for c=1 . . . K

Because the constraints are to be satisfied exactly, they may be rewritten in terms of new parameters z(k₁), . . . ,z(k_{K}) as follows

X(k)=Cₖ+z(k)d(vₖ) for kε{k₁, . . . ,k_{K}}. (5)

The unknowns are collected into a parameter vector θ, defined as

θ={X(1) . . . X(n),z(k₁), . . . z(kₙ)}.

The above set of constraints is linear in θ and ε is quadratic in θ so the constrained minimization is readily solved using a standard quadratic solver.

Embodiments using the arc-length cost are now described.

### Shortest-Path Trajectory

Using the arc-length cost rather than the TPS cost gives a minimization problem which is not quadratic in the unknowns, but which can be simplified by noting that the segments between keyframes must be linear. Therefore the unknowns are reduced to the K depths

θ={z(k₁), . . . ,z(kⁿ)},

and the smoothness term becomes

$$ɛ ( θ ) = {\sum }_{c = 2}^{K} ‖ X ( {k}_{c} ) - X ( {k}_{c - 1} ) ‖ . \qquad ( 6 )$$

Minimizing (6) subject to the constraints (5) is now a nonlinear optimization problem which may be solved using standard numerical methods. Such methods require an initial estimate of the solution.

Therefore we also use an ad hoc initialization which provides good results in practice, which shall now be described. Consider all pairs of successive keyframes, so that, for example, the pairs (k1,k2) and (k2,k3) would be considered. For a given pair, with indices (h,k), find the point of closest approach of the two 3D rays

Rₕ(vₕ)=Cₕ+zdₕ(vₕ)|0<z<∞ (7)

Rₖ(vₖ)=Cₖ+zdₖ(vₖ)|0<z<∞ (8)

which is easily obtained in closed form.

This process associates with each keypoint (except the first and last) a pair of 3D points on its 3D ray. Selecting the midpoint of this pair yields a unique point on the ray. Linearly interpolating these points between keyframes gives an approximation to the minimizing trajectory which may be used immediately, or as an initial estimate for the minimization of (6).

### Example User Interface

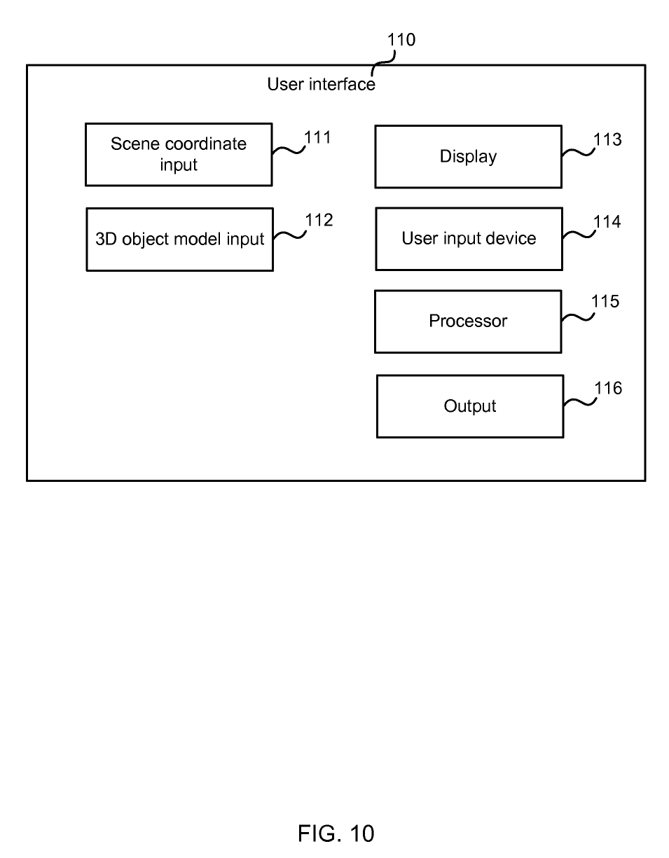

FIG. 10 is a schematic diagram of an apparatus for in-scene editing of a sequence of images. It comprises a user interface 110 having a display 113 such as a liquid crystal display screen, a computer screen, a video camera display screen or any other suitable type of display for showing image sequences. A user input device 114 is also provided such as a keyboard and mouse or any other suitable user input device such as a touch screen, track ball, or other user input apparatus. A processor is provided 115 of any suitable type such as a computer and an output 116 enables output to the display 113 and or any other apparatus to be made. Inputs are provided 111, 112 to receive the scene coordinate information and the 3D object model information.

### Exemplary Computing-Based Device

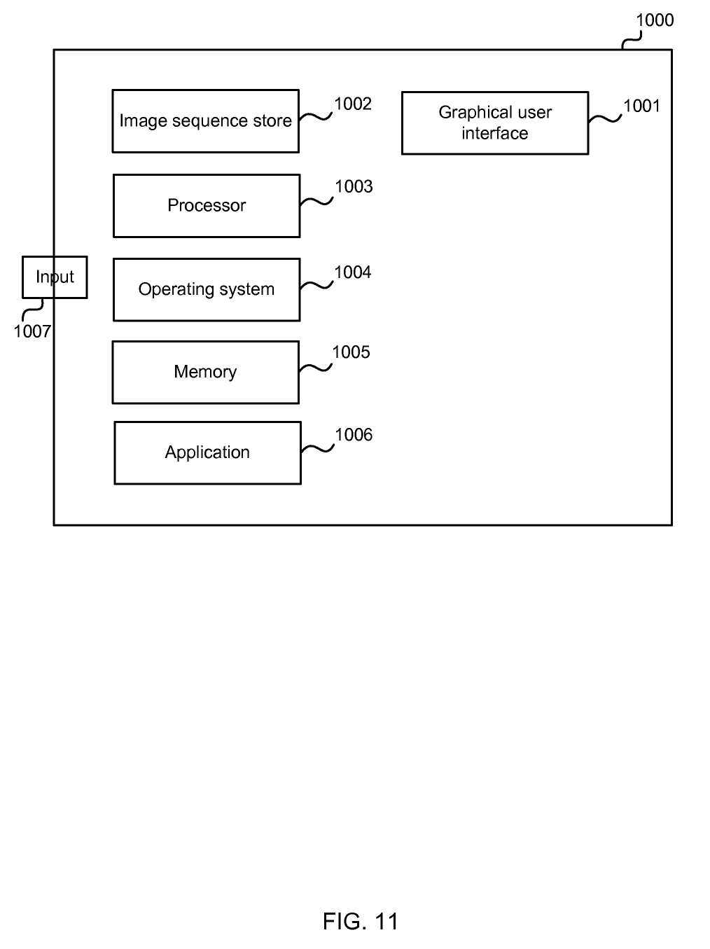

FIG. 11 illustrates various components of an exemplary computing-based device 1000 which may be implemented as any form of a computing and/or electronic device, and in which embodiments of a system for in-scene editing of image sequences may be implemented.

The computing-based device 1000 comprises one or more inputs 1007 which are of any suitable type for receiving sequences of images. The sequence of images is stored at image sequence store 1002 which is of any suitable type.

Computing-based device 1000 also comprises one or more processors 1003 which may be microprocessors, controllers or any other suitable type of processors for processing computing executable instructions to control the operation of the device in order to assist a user with in-scene editing of a sequence of images. Platform software comprising an operating system 1004 or any other suitable platform software may be provided at the computing-based device to enable application software 1006 to be executed on the device to provide in-scene image sequence editing.

The computer executable instructions may be provided using any computer-readable media, such as memory 1005. The memory is of any suitable type such as random access memory (RAM), a disk storage device of any type such as a magnetic or optical storage device, a hard disk drive, or a CD, DVD or other disc drive. Flash memory, EPROM or EEPROM may also be used.

An output is also provided such as an audio and/or video output to a display system integral with or in communication with the computing-based device. The display system provides a graphical user interface 1001, or other user interface of any suitable type.

The term ‘computer’ is used herein to refer to any device with processing capability such that it can execute instructions. Those skilled in the art will realize that such processing capabilities are incorporated into many different devices and therefore the term ‘computer’ includes PCs, servers, mobile telephones, personal digital assistants and many other devices.

The methods described herein may be performed by software in machine readable form on a storage medium. The software can be suitable for execution on a parallel processor or a serial processor such that the method steps may be carried out in any suitable order, or simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Any range or device value given herein may be extended or altered without losing the effect sought, as will be apparent to the skilled person.

It will be understood that the benefits and advantages described above may relate to one embodiment or may relate to several embodiments. It will further be understood that reference to ‘an’ item refer to one or more of those items.

The steps of the methods described herein may be carried out in any suitable order, or simultaneously where appropriate. Additionally, individual blocks may be deleted from any of the methods without departing from the spirit and scope of the subject matter described herein.

It will be understood that the above description of a preferred embodiment is given by way of example only and that various modifications may be made by those skilled in the art. The above specification, examples and data provide a complete description of the structure and use of exemplary embodiments of the invention. Although various embodiments of the invention have been described above with a certain degree of particularity, or with reference to one or more individual embodiments, those skilled in the art could make numerous alterations to the disclosed embodiments without departing from the spirit or scope of this invention.

1. A method comprising:
accessing a scene coordinate system for a sequence of images of a scene;
receiving a 3D object model;
displaying an image in the sequence as selected by a user and displaying the 3D object model at a default position in that image;
receiving a user input and modifying a set of projection constraints on the basis of that user input;
computing a 3D motion trajectory in the scene coordinate system which optimizes the modified set of projection constraints and which also optimizes a smoothness indicator;
transforming the 3D object model in a display of the image sequence on the basis of the computed trajectory.

2. A method as claimed in claim 1 wherein the 3D object model is of a single point.

3. A method as claimed in claim 1 wherein the 3D object model comprises a polygonal mesh.

4. A method as claimed in claim 1 wherein the 3D object model comprises one or more specified control points.

5. A method as claimed in claim 1 wherein the 3D object model comprises advertising material.

6. A method as claimed in claim 1 wherein the smoothness indicator is a thin-plate spline smoothness indicator.

7. A method as claimed in claim 1 wherein the smoothness indicator is based on arc-length.

8. A method as claimed in claim 1 wherein the received user input comprises a user action specifying a 2D target position on an image from the sequence.

9. A method as claimed in claim 1 wherein the received user input comprises a user action specifying a rotation.

10. A method as claimed in claim 1 wherein the projection constraints are hard constraints.

11. A method as claimed in claim 1 wherein at least one projection constraint comprises a 2D point in a image of the image sequence to which a specified control point on the 3D object model must project in the scene coordinate system.

12. A user interface comprising:
an input arranged to access a scene coordinate system for a sequence of images of a scene;
an input arranged to receive user information specifying a 3D object model;
a display arranged to display an image in the sequence as selected by a user and also to display the 3D object model at a default position in that image;
an input arranged to receive a user input to modify a set of projection constraints on the basis of that user input;
a processor arranged to compute a 3D motion trajectory in the scene coordinate system which optimizes the modified set of projection constraints and which also optimizes a smoothness indicator; and
an output arranged to display the image sequence and to transform the 3D object model in that image sequence on the basis of the computed trajectory.

13. A user interface as claimed in claim 12 wherein the display arranged to display an image in the sequence as selected by a user comprises a timeline together with marks on the timeline to indicate the position of images in the sequence which have associated projection constraints.

14. A user interface as claimed in claim 12 wherein the input arranged to receive a user input to modify a set of projection constraints is arranged to receive only 2D position information.

15. A user interface as claimed in claim 12 wherein the input arranged to receive a user input to modify a set of projection constraints is arranged to receive information about a control point on the 3D object model dragged onto a feature in an image of the sequence.

16. A user interface as claimed in claim 12 wherein the 3D object model comprises advertising material.

17. One or more device-readable media with device-executable instructions for performing steps comprising:
accessing a scene coordinate system for a sequence of images of a scene;
receiving a 3D object model;
displaying an image in the sequence as selected by a user and displaying the 3D object model at a default position in that image;
receiving a user input and modifying a set of projection constraints on the basis of that user input; and
computing and storing a 3D motion trajectory in the scene coordinate system which optimizes the modified set of projection constraints and which also optimizes a smoothness indicator.

18. One or more device-readable media as claimed in claim 17 wherein the device-executable instructions are further arranged to transform the 3D object model in a display of the image sequence on the basis of the computed trajectory.

19. One or more device-readable media as claimed in claim 17 wherein the device-executable instructions are further arranged to receive user input comprising a user action specifying a 2D target position on an image from the sequence.

20. One or more device-readable media as claimed in claim 17 wherein the device-executable instructions are further arranged to receive user input specifying a rotation.
